(19) United States
(12) Patent Application Publication
(10) Pub. No.: US 2022/0389968 A1
(43) Pub. Date: Dec. 8, 2022

(54) ROLLING BEARING

(71) Applicant: Aktiebolaget SKF, Goteborg (SE)

(72) Inventors: Pieter Martin Lugt, TA Vianen (NL); He Zhu, Shanghai (CN)

(21) Appl. No.: 17/829,991

(22) Filed: Jun. 1, 2022

(30) Foreign Application Priority Data
Jun. 7, 2021 (CN) 202110631934.5

(51) Int. Cl. F16C 33/66; F16C 19/16

(52) U.S. Cl. CPC F16C 33/6681; F16C 19/16

(57) ABSTRACT

A rolling bearing having an inner ring, an outer ring and a plurality of rolling elements being arranged between the inner ring and the outer ring is provided. The inner ring and the outer ring each include a raceway for the plurality of rolling elements. Each raceway encompasses the plurality of rolling elements symmetrically. The rolling bearing further includes an asymmetric cage being arranged between the inner ring and the outer ring for holding the rolling elements. The rolling bearing is lubricated by a lubricant being arranged on each axial side of the plurality of rolling elements. The raceways are offset in the same axial direction from the axial center of the inner ring and the outer ring such that the shear rate acting on the lubricant is equal on each axial side of the rolling bearing.

### CROSS-REFERENCE TO RELATED APPLICATIONS

This application claims priority to Chinese Patent Application no. 202110631934.5, filed Jun. 7, 2021, the contents of which is fully incorporated herein by reference.

### TECHNICAL FILED OF THE INVENTION

The present invention relates to a rolling bearing.

### BACKGROUND OF THE INVENTION

Rolling bearings, for example ball bearings like deep groove ball bearings, typically comprise an inner ring, an outer ring and rolling elements, for example balls, arranged therebetween, wherein the rolling elements are usually accommodated in a cage. Grooves are machined into the rings, wherein the grooves form raceways and are axially symmetrically arranged. Thus, the raceways are disposed symmetrically around the axial center of the inner ring and the outer ring. For a simplified mounting of the rolling elements into the cage often asymmetrical cages, like a snap-type cage with a backbone side and a pronged side, are used. Even if such a cage may simplify the mounting, it has the disadvantage that lubricant, which may be present in the rolling bearing, may be nonuniformly distributed and supplied to the rolling elements due to the different dynamics triggered by the asymmetrical cage. Such an unsymmetrical distribution of lubricant may lead to a nonuniform lubrication of the bearing, in particular of the rolling elements and raceways.

This is due to the fact that the lubricant, for example grease, may be exposed to different shear strain rates. Lubricant, in particular grease, is a shear thinning fluid. This means that the viscosity (η) of grease is a function of the shear rate (\dot{γ}). The shear rate (\dot{γ}) is the rate per second (s⁻¹) at which a shearing deformation is applied to the lubricant.

η=η(\dot{γ}) (1)

This also applies to lubricating oils but is much stronger for grease.

When the grease is stationary (\dot{γ}=0), then it is like a solid (like butter). But when shearing starts, it becomes kind of fluid. At very high shear rates, the viscosity of the grease approaches that of the base oil (grease=thickener+base oil). The shear rate is defined as

$$\dot{γ} = \frac{Δ u}{h} \qquad ( 2 )$$

This means that, when grease is arranged between two rotating flat plates, then the shear rate is equal to the difference of the speed (Δu) and the gap (h) between the plates. In the case of a bearing, the grease is arranged between the rolling elements and sealing elements being arranged at the axial sides of the bearing. The two rotating plates are in this case represented by the rolling elements and the sealing elements or, when a cage is provided, by the cage and the sealing elements.

Typically, the bearing is initially filled with grease. It is not completely packed with grease. Usually around 30% of the free volume of the bearing is filled with grease. When the bearing starts rotating, then the rolling elements will very quickly push grease to both sides of the bearing (this is called “channeling”), where the grease will further be flowing (sheared) between the rolling elements and the seals being arranged at the axial sides of the bearing. This is a very dynamic process. In a simplified summary, the grease is sheared left and right of the rolling elements that are traveling through this channel of grease. This process has a finite duration. It typically takes about 1 to 24 hours.

After this, the so called “unswept” volume, i.e., the volume left and/or right of the rolling elements, is totally filled with grease. Excess of grease within this volume will have leaked out through the seals. The rolling elements hardly touch the grease anymore. This process is called “clearing”. The raceways have been totally cleared with grease. There will only be a very thin layer of oil left to lubricate the contacts. The contacts are now continuously fed by oil from the stationary grease (this is called “bleed”).

In order to make this happen for a very long time, the grease should not get lost from the bearing. This means that as much as possible of the grease should be kept in the bearing. The bleed rate is not only determined by the volume of the grease but also by the properties of the grease. The grease is degrading by shearing, but also by being over-rolled by the rolling elements (mechanical degradation). Hence, for getting a long life of the grease, and thus of the bearing, it is helpful to ensure that the channeling and clearing phase are as short as possible but also the transverse flow of grease (from on axial side of the bearing to the other axial side of the bearing) should be minimized. This means that the grease needs to be moved away from the contacts as soon as possible and it should not come back.

If the bearing is non-symmetric, like it is the case for a bearing with an asymmetric cage having a backbone side and a pronged side, then the shear rates left and right will be different and therefore there are different grease viscosities left and right. Different shear rates occur, as on one side of the bearing, the grease is sheared between the surfaces of the rolling elements and a sealing element and, on the other side of the bearing, the grease is sheared between the cage and the sealing element. As the shear rate depends also on the gap between the rotating plates (i.e., rolling elements and sealing element on the one side of the bearing or cage and sealing element on the other side of the bearing) see equation (2), the shear rate is higher on the side of the backbone side of the cage, where the cage has a smaller distance to the sealing element than the rolling elements to the sealing element.

Different shear rates and thus different grease viscosities will induce a transverse flow during the channeling and clearing phase. Such a transverse flow leads to an increased mechanical degradation of the grease due to the above-mentioned over-rolling of the grease by the rolling elements.

It is therefore object of the present invention to provide a rolling bearing having reduced negative effects on the lubricant and thus having an improved lubrication.

### SUMMARY OF THE INVENTION

The rolling bearing comprises an inner ring, an outer ring and a plurality of rolling elements being arranged between the inner ring and the outer ring. The rolling bearing may be a ball bearing, in particular a deep groove ball bearing, and the rolling elements may be balls. Alternatively, the rolling bearing may also be a roller bearing and the rolling elements may be rollers.

The inner ring and the outer ring each comprise a raceway for the plurality of rolling elements, wherein each raceway encompasses the plurality of rolling elements symmetrically. The rolling bearing is lubricated by a lubricant, for example grease, being arranged on each axial side of the bearing. Further, the rolling bearing comprises a cage being arranged between the inner ring and the outer ring for holding the rolling elements. The cage is particularly asymmetric, which means that the cage has a different form on each axial side of the bearing.

As described above, an asymmetric cage has the disadvantage that the shear rates left and right will be different and therefore there are different grease viscosities left and right. Such different viscosities lead to a transverse flow of the lubricant, for example grease, from one axial side of the bearing to the other axial side of the bearing during the channeling and clearing phase, which in turn leads to a degradation of the lubricant due to being over-rolled by the rolling elements.

Thus, in order to reduce the transverse flow and to reduce the negative effect on the lubricant, the raceways of the rolling bearing are offset in the same axial direction from the axial center of the inner ring and the outer ring (in contrast to a symmetric arrangement like in conventional rolling bearings, in particular conventional ball bearings). The offset of the raceways is determined to be such that the shear rate acting on the lubricant is equal on each side of the rolling bearing. Equal shear rates on both axial sides of the bearing lead to equal viscosities despite of the asymmetric cage and thus to a reduced transverse flow of the lubricant. Hence, the degradation of the lubricant may be reduced compared to conventional rolling bearings.

As the transverse flow is reduced, it may also be avoided that one side of the bearing may become overfilled which would to a leakage of the lubricant excess and thus to a poor lubrication in the whole bearing. Thus, by having the arrangement as described above, also loss of lubricant may be avoided which further improves the lubrication situation over the lifetime of the bearing.

The asymmetric cage may for example be a snap-type cage having a backbone side and a pronged side. Such a snap-type cage may be advantageous as the rolling elements, for example balls, may be easily snapped in, which simplifies the assembly of the rolling bearing.

According to a further embodiment, the rolling bearing further comprises sealing elements which are arranged at both axial ends of the rolling bearing. The sealing elements seal the bearing against contaminants from outside the bearing into the bearing and against lubricant leakage from inside the bearing to the outside. The sealing elements may comprise for example an elastic material, like rubber or polymer, but may also comprise a combination of materials.

According to a further embodiment, equal shear rates on both sides of the rolling bearing may be achieved by making the volume being defined between the inner ring, the outer ring, the backbone side of the cage and one sealing element equal to the volume defined between the inner ring, the outer ring, the rolling elements, and the other sealing element.

One approach for having, at least substantially, equal shear rates on both axial sides of the rolling bearing is to make the volumes on both sides of the bearing equal. This is only an approximation but represents an easy way to provide more or less the same shear rates on both axial sides of the bearing, which again leads to equal viscosities on both sides and thus to a reduced transverse flow of the lubricant.

Another possibility of achieving equal shear rates on both axial sides of the bearing is to make the distance between the backbone side of the cage and one sealing element equal to the distance between the rolling elements and the other sealing element.

When a symmetric arrangement of the raceways with an asymmetric cage is used as it is the case in conventional rolling bearings, the shear rates on the backbone side of the cage are higher than on the pronged side. As explained above, the shear rate depends on the gap between the rotating plates. Thus, the shear rate is higher on the side of the backbone side of the cage, where the distance from the cage to the axial end of the rolling bearing, for example a sealing element, is smaller than the distance from the rolling elements to the other axial end of the rolling bearing, for example another sealing element.

Thus, based on the above, it can be deduced that the shear rates may be made equal on both axial sides of the bearing by making the distance between the backbone side of the cage and one sealing element equal to the distance between the rolling elements and the other sealing element.

In the following, this will be explained in further detail based on a simplified calculation approach for the example of a ball bearing.

Here, it is assumed that the backbone side of the cage is almost touching the outer ring and inner ring shoulder so that there is no space between backbone and rings. Further, the effect of ball rotation is neglected, and it is assumed that the ball rotational speed n_{b} (in revolutions per minute) is half the inner ring speed n.

$$\begin{matrix}{n}_{b} = \frac{1}{2} n & ( 3 ) \\ {u}_{b} = \frac{π {d}_{m}}{60} {n}_{b} & ( 4 )\end{matrix}$$

where u_{b} is the ball rotational speed in m/s and dₘ is the mean bearing diameter. The mean bearing diameter is calculated as (D+d)/2, wherein D is the outer diameter of the bearing and d is the bore diameter.

When it is assumed that the curvature of the ball can be approximated by a parabola. Then the shear rate on the right side of the bearing (the side having no cage) can be calculated as:

$${\dot{γ}}_{r} = \frac{\frac{π {d}_{m}}{ε0} {n}_{b}}{( {l}_{g} - R ) + \frac{{x}^{2}}{2 R}} \qquad ( 5 )$$

wherein l_{g} denotes the distance between the sealing element and the axial center X of the balls, R denotes the radius of the balls, and x denotes the distance between the radial center of the bearing and the inner ring and outer ring.

On the left side of the bearing, i.e., the side having the backbone side of the cage, the shear rates can be calculated as:

$${\dot{γ}}_{l} = \frac{\frac{π {d}_{m}}{60} n -}{{h}_{l}} \qquad ( 6 )$$

wherein hₗ denotes the distance between the backbone side of the cage to the sealing element, with hₗ=(B−l_{g}−R−h_{c}), where B is the axial length of the bearing and h_{c} is the thickness of the backbone of the cage. The difference between the shear rate on the left and right should be, in theory, equal to zero so that:

$$\begin{matrix}{l}_{g} = \frac{1}{H} {\int }_{- \frac{1}{2} H}^{\frac{1}{2} H} \frac{1}{2} ( B - {h}_{c} - \frac{{x}^{2}}{2 R} ) dx & ( 12 ) \\ {l}_{g} = \frac{B - {h}_{c}}{2} - \frac{{H}^{2}}{48 R} & ( 13 )\end{matrix}$$

Or

$$\frac{\frac{π {d}_{m}}{60} {n}_{b}}{( {l}_{g} - R ) + \frac{{x}^{2}}{2 R}} - \frac{\frac{π {d}_{m}}{60} n -}{( B - {l}_{g} - R - {h}_{c} )} = 0 \qquad ( 7 )$$

This can be further simplified by assuming that the depth of the groove on the outer ring is equal to that on the inner ring:

$$\begin{matrix}\frac{1}{( {l}_{g} - R ) + \frac{{x}^{2}}{2 R}} - \frac{1}{( B - {l}_{g} - R - {h}_{c} )} = 0 & ( 8 ) \\ ( {l}_{g} - R ) + \frac{{x}^{2}}{2 R} = ( B - {l}_{g} - R - {h}_{c} ) & ( 9 ) \\ 2 {l}_{g} = B - {h}_{c} - \frac{{x}^{2}}{2 R} & ( 10 ) \\ {l}_{g} = \frac{1}{2} ( B - {h}_{c} - \frac{{x}^{2}}{2 R} ) & ( 11 )\end{matrix}$$

wherein H is the distance between the inner ring and the outer ring. The last equation (13) may then be used for calculating hₗ. i.e., the distance between the backbone side of the cage and the sealing element and thus the offset of the raceways in the axial direction of the rolling bearing.

It should be noted that the above explained calculation is simplified and only exemplary and that other calculation approaches may be used.

In the above provided embodiments, the shear rate in its entirety is made equal on both axial sides of the bearing. Instead of calculating and considering the shear rate in its entirety, it is possible to calculate the shear rate in a more detailed way, i.e., at each point of the space defined on each axial side of the bearing.

This means that, according to a further embodiment, the raceways are offset in the same axial direction from the axial center of the inner ring and the outer ring such that the shear rate acting on the lubricant at each point of the space defined between the inner ring, the outer ring, the backbone side of the cage and one sealing element is equal to the shear rate acting on the lubricant at each point of the space defined between the inner ring, the outer ring, the rolling elements and the other sealing element. Here, the shear rate may be calculated for each point Pₗ, or at least a plurality of points Pₗ, of the respective space on one side of the bearing. The position of the raceways may then be optimized such that the shear rate \dot{γ}(Pₗ) on this side of the bearing is equal to the shear rate \dot{γ}(Pᵣ) of each point Pᵣ, or at least a plurality of points Pᵣ, of the respective space on the other side of the bearing. Although this approach is complex, it may provide a well optimized position, i.e., offset, of the raceways.

According to a further embodiment, the cage comprises a polymer material. This provides the advantage of a lightweight cage. Further, the polymer cage provides an improved snap-in function as the polymer material may be flexible and the rolling elements may easily be snapped-in. Of course, the cage may also be made from different materials, for example metal, depending on design considerations.

### BRIEF DESCRIPTION OF THE DRAWINGS

Further preferred embodiments are defined in the dependent claims as well as in the description and the figures. Thereby, elements described or shown in combination with other elements may be present alone or in combination with other elements without departing from the scope of protection.

At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings. In the following, preferred embodiments of the invention are described in relation to the drawings, wherein the drawings are exemplarily only, and are not intended to limit the scope of protection. The scope of protection is defined by the accompanied claims, only.

The figures show:

FIG. 1: a cross sectional view of a rolling bearing according to the prior art;

FIG. 2: a cross sectional view of a cage for a rolling bearing; and

FIG. 3: a cross sectional view of a rolling bearing according to the invention.

### DETAILED DESCRIPTION OF THE INVENTION

Those of ordinary skill in the art will appreciate from this disclosure that when a range is provided such as (for example) an angle/distance/number/weight/volume/spacing being between one (1 of the appropriate unit) and ten (10 of the appropriate units) that specific support is provided by the specification to identify any number within the range as being disclosed for use with a preferred embodiment. For example, the recitation of a percentage of copper between one percent (1%) and twenty percent (20%) provides specific support for a preferred embodiment having two point three percent (2.3%) copper even if not separately listed herein and thus provides support for claiming a preferred embodiment having two point three percent (2.3%) copper. By way of an additional example, a recitation in the claims and/or in portions of an element moving along an arcuate path by at least twenty (20°) degrees, provides specific literal support for any angle greater than twenty (20°) degrees, such as twenty-three (23°) degrees, thirty (30°) degrees, thirty-three-point five (33.5) degrees, forty-five (45°) degrees, fifty-two (52°) degrees, or the like and thus provides support for claiming a preferred embodiment with the element moving along the arcuate path thirty-three-point five (33.5°) degrees. In the following same or similar functioning elements are indicated with the same reference numerals.

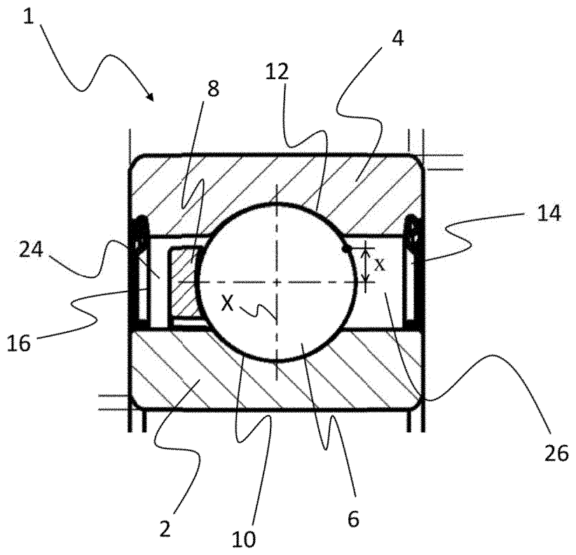

FIG. 1 shows a rolling bearing 1 of the prior art. In this exemplary illustration, the rolling bearing 1 is a ball bearing having balls. However, it should be noted that the bearing 1 may also be any other kind of rolling bearing, for example a roller bearing.

The ball bearing 1 comprises an inner ring 2, an outer ring 4 and a plurality of balls 6 being arranged between the inner ring 2 and the outer ring 4. The balls 6 are hold by an asymmetric cage 8.

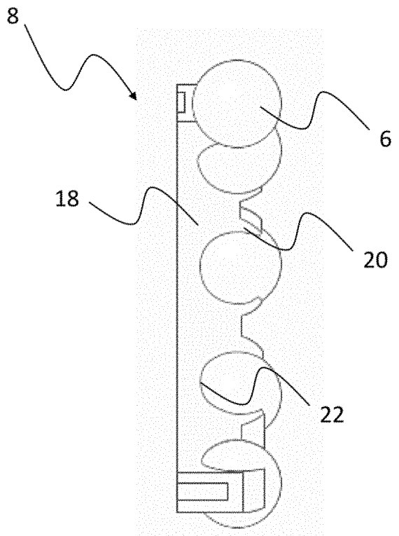

The cage 8 may be a snap-type, in particular ball-guided, cage having a backbone side 18 and a pronged side 20 (see FIG. 2). The backbone side 18 of the cage 8 is arranged at the axially left side 24 of the bearing 1, wherein the pronged side 20 is directed towards the axially right side 26 of the bearing 1 and is arranged in between the balls 6. The pronged arrangement forms pockets 22 in which the balls 6 may be snapped in.

Each ring 2, 4 comprises a raceway 10, 12 which encompass the balls 6 in a symmetrical way. As can be seen, the raceways 10, 12 are arranged symmetrically in the axial direction with respect to an axial center X of the bearing 1. Seal elements 14, 16 are arranged on both axial sides 24, 26 of the bearing 1.

When the bearing 1 is filled with lubricant, in particular grease, the lubricant may be exposed to different strains, i.e., shear rates, on both axial sides 24, 26 of the bearing 1. As the bearing 1 is non-symmetric, due to the asymmetric cage 8 having a backbone side and a pronged side, the shear rates left and right will be different and therefore there are different grease viscosities left and right. Different shear rates occur, as on one side 26 of the bearing 1, the grease is sheared between the surfaces of the balls 6 and a sealing element 14 and, on the other side 24 of the bearing 1, the grease is sheared between the cage 8 and the sealing element 16. As explained above, the shear rate depends on the gap between the rotating plates (i.e., balls 6 and sealing element 14 or cage 8 and sealing element 16), and therefore the shear rate is higher on the side 24 of the backbone side of the cage 8.

Different shear rates and thus different grease viscosities will induce a transverse flow from left 24 to right 26. Such a transverse flow leads to an increased mechanical degradation of the grease due to the above-mentioned over-rolling of the grease by the balls 6.

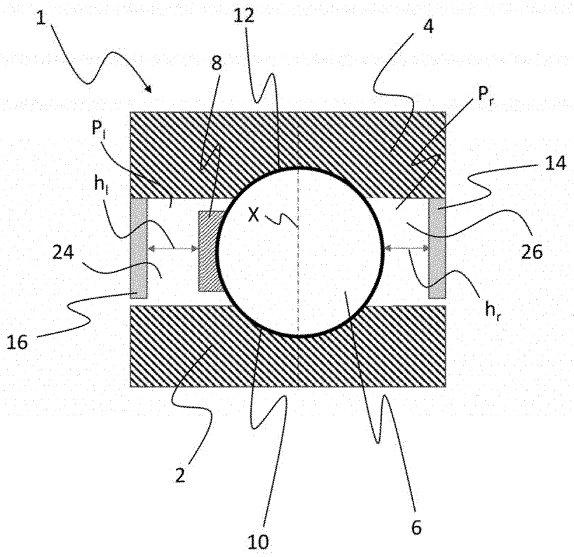

On order to overcome these negative effects, in particular to reduce the transverse flow and to reduce the negative effect on the lubricant, the rolling bearing 1 as shown in FIG. 3 has raceways 10, 12 which are offset in the same axial direction from the axial center X of the inner ring 2 and the outer ring 4 such that the shear rates on both sides 24, 26 of the rolling bearing 1 are equal.

It should be noted that, although the illustrated bearing 1 is a ball bearing, the bearing 1 may also be any other kind of rolling bearing, for example a roller bearing, having any kind of rolling elements, for example rollers. For the sake of convenience, the ball bearing 1 will be described but the description and explanations may also apply to any other kind of rolling bearing.

The offset of the raceways 10, 12 is such that the shear rate acting on the lubricant is equal on each side 24, 26 of the rolling bearing 1. Equal shear rates on both axial sides 24, 26 of the bearing 1 lead to equal viscosities despite of the asymmetric cage 8 and thus to a reduced transverse flow of the lubricant. Hence, the degradation of the lubricant may be reduced compared to conventional rolling bearings.

The offset of the raceways 10, 12 and the equal shear rates may be achieved according to different considerations. Some of them will be described in the following.

According to one example, equal shear rates on both sides 24, 26 of the rolling bearing 1 may be achieved by making the volume being defined between the inner ring 2, the outer ring 4, the backbone side 18 of the cage 8 and one sealing element 16 equal to the volume defined between the inner ring 2, the outer ring 4, the balls 6 and the other sealing element 14. Equal volumes on each side 24, 26 of the bearing 1 leads to, at least substantially, equal shear rates on both axial sides 24, 26 of the rolling bearing 1.

Alternatively, equal shear rates on both axial sides 24, 26 of the bearing 1 may be achieved by making the distance hₗ between the backbone side 18 of the cage 8 and one sealing element 16 equal to the distance hᵣ between the balls 8 and the other sealing element 16.

As explained above, the shear rate depends on the gap between the rotating plates between which the lubricant or grease is arranged. Thus, in a conventional bearing like the rolling bearing of FIG. 1, the shear rate is higher on the side of the backbone side 18 of the cage 8, where the distance hₗ from the cage 8 to the sealing element 14 is smaller than the distance hᵣ from the balls 6 to the sealing element 16.

Thus, by making the distance hₗ between the backbone side 18 of the cage 8 and the sealing element 14 equal to the distance hᵣ between the balls 8 and the sealing element 16, as shown in FIG. 3, the shear rates may also be made equal on both axial sides 24, 26 of the bearing 1.

Another, more complex approach is to calculate the shear rate \dot{γ}(Pₗ) acting on the lubricant at each point Pₗ of the space 24 defined between the inner ring 2, the outer ring 4, the backbone side 18 of the cage 8 and the sealing element 16 and the shear rate \dot{γ}(Pᵣ) acting on the lubricant at each point Pᵣ of the space 26 defined between the inner ring 2, the outer ring 4, the balls 6 and the sealing element 14. The position and offset of the raceways 10, 12 may then be determined such that the shear rate \dot{γ}(Pₗ) at each point Pₗ is equal to the shear rate \dot{γ}(Pᵣ) at each point Pᵣ. This means that the shear rate for one specific point Pₗ on the left side 24 is equal to the shear rate for the corresponding point Pᵣ on the right side 26. Thus, in contrast to look at the shear rate on the left 24 and right 26 side as a whole, the shear rate may be considered in this case in a very detailed way.

It should be noted that, although the backbone side 18 is shown to be on the axially left side, the overall arrangement of the bearing 1 may also be inverted, i.e., the backbone side 18 may be on the axially right side 26.

In summary, independent of the specific design configurations as explained above based on illustrative examples, the raceways 10, 12 are offset to the axial center X of the bearing 1 so that the shear rates acting on the lubricant are made equal on both sides 24, 26 of the bearing 1. Equal shear rates reduce the transverse flow and thus the mechanical degradation of the lubricant, as explained above.

1. A rolling bearing comprising:
an inner ring,
an outer ring, and
a plurality of rolling elements being arranged between the inner ring and the outer ring, wherein
the inner ring and the outer ring each comprise a raceway for the plurality of rolling elements, wherein
each raceway encompasses the plurality of rolling elements symmetrically, wherein
the rolling bearing further comprises an asymmetric cage being arranged between the inner ring and the outer ring for holding the rolling elements, wherein
the rolling bearing is lubricated by a lubricant being arranged on each axial side of the plurality of rolling elements, and wherein
the raceways are offset in the same axial direction from the axial center of the inner ring and the outer ring such that the shear rate acting on the lubricant is equal on each axial side of the rolling bearing.

2. The rolling bearing according to claim 1, wherein the cage is a snap-type cage and comprises a backbone side and a pronged side.

3. The rolling bearing according to claim 1, further comprising sealing elements that are arranged at both axial ends of the rolling bearing.

4. The rolling bearing according to claim 1, wherein the volume defined between the inner ring, the outer ring, the backbone side of the cage and one sealing element is equal to the volume defined between the inner ring, the outer ring, the rolling elements and the other sealing element.

5. The rolling bearing according to claim 1, wherein the distance between the backbone side of the cage and one sealing element is equal to the distance between the rolling elements and the other sealing element.

6. The rolling bearing according to claim 1, wherein the raceways are offset in the same axial direction from the axial center of the inner ring and the outer ring such that the shear rate acting on the lubricant at each point of the space defined between the inner ring, the outer ring, the backbone side of the cage and one sealing element is equal to the shear rate acting on the lubricant at each point of the space defined between the inner ring, the outer ring, the rolling elements and the other sealing element.

7. The rolling bearing according to claim 1, wherein the cage comprises a polymer material.

8. The rolling bearing according to claim 1, wherein the rolling bearing is a ball bearing and the rolling elements are balls.

9. The rolling bearing according to claim 8, wherein the ball bearing is a deep groove ball bearing.
